(19) United States
(12) Patent Application Publication
(10) Pub. No.: US 2015/0198133 A1
(43) Pub. Date: Jul. 16, 2015

(54) ENGINE COOLANT TEMPERATURE REGULATION APPARATUS AND METHOD

(71) Applicant: Caterpillar Inc., Peoria, IL (US)

(72) Inventors: Benjamin BALLARD, Lafayette, IN (US); Krishna BOMIREDDY, Naperville, IL (US); Patrick HART, West Lafayette, IN (US)

(73) Assignee: Caterpillar Inc., Peoria, IL (US)

(21) Appl. No.: 14/151,894

(22) Filed: Jan. 10, 2014

(51) Int. Cl. F02N 19/10

(52) U.S. Cl. CPC F02N 19/10

(57) ABSTRACT

A standby system includes a pump, a heater, a sensor, and a controller. The pump is fluidly coupled to a power source and configured to convey a coolant therethrough. The heater is thermally coupled to the coolant and configured to impart an amount of heat into the coolant. The sensor is thermally coupled to the coolant. The controller is operatively coupled to the heater and the sensor. The controller configured to receive a plurality of signals over time from the sensor, determine a temperature profile based on the plurality of signals, compare the temperature profile to a predetermined temperature profile, modulate the heater to increase the amount of heat in response to the temperature profile being relatively more shallow than the predetermined temperature profile, and modulate the heater to decrease the amount of heat in response to the temperature profile being relatively steeper than the predetermined temperature profile.

### TECHNICAL FIELD

This patent disclosure relates generally to maintaining engine coolant temperature and, more particularly, to an engine coolant heating system and method for maintaining the coolant temperature of an engine in standby mode.

### BACKGROUND

Engines may be maintained in ‘standby’ mode for a variety of reasons. A common usage of a standby engine is to power an electric generator in the event of a main electrical outage. When packaged together, engine and generator combinations are often referred to as, ‘gensets.’ Typically, a building such as a hospital will have a genset to provide emergency power. In this role, it is important that the engine genset be reliable capable of starting quickly. While relatively small gensets may include gasoline engines, relatively larger gensets typically employ diesel engines. As is generally known, diesel engines start more reliably when the temperature of the combustion chamber is above a predetermined minimum starting temperature of about 100° F. (38° C.).

To maintain this minimum starting temperature in ambient temperatures that fall below it, engines may include a heater. For example, Canadian patent CA1197542A1 (hereinafter “the '542 publication”), entitled “Engine Block Heater with Integrated Thermostatic Control,” purports to describe an engine heating system to maintain the temperature of the engine block. However, the heating system of the '542 publication does not provide flexibility for controlling the rate of heating which can lead to premature failure of components and excessive energy consumption.

Accordingly, there is a need for an improved engine heating system to address the problems described above and/or problems posed by other conventional approaches.

### SUMMARY

The foregoing needs are met, to a great extent, by the present disclosure, wherein aspects of a standby system and method of operating a standby system are provided.

An embodiment of the present disclosure pertains to a standby system. The standby system includes a pump, a heater, a sensor, and a controller. The pump is fluidly coupled to a power source and configured to convey, transmit, or otherwise move a flow of a fluid through the power source. The heater is thermally coupled to the coolant and configured to impart an amount of thermal energy into the coolant. The sensor is thermally coupled to the coolant. The controller is operatively coupled to the heater and the sensor. The controller configured to receive a plurality of signals over time from the sensor, determine a temperature profile based on the plurality of signals over time, compare the temperature profile to a predetermined temperature profile, modulate the heater to increase the amount of thermal energy in response to the temperature profile being relatively more shallow than the predetermined temperature profile, and modulate the heater to decrease the amount of thermal energy in response to the temperature profile being relatively steeper than the predetermined temperature profile.

Another embodiment of the present disclosure relates to a method of operating a standby system. The standby system includes a pump fluidly coupled to a power source and configured to urge a flow of a fluid through the power source, a heater thermally coupled to the coolant and configured to impart an amount of thermal energy into the coolant, a sensor thermally coupled to the coolant, and a controller operatively coupled to the heater and the sensor. In the method, a plurality of signals are received over time from the sensor, a temperature profile is determined based on the plurality of signals over time, the temperature profile is compared to a predetermined temperature profile, the heater is modulated to increase the amount of thermal energy in response to the temperature profile being relatively more shallow than the predetermined temperature profile, and the heater is modulated to decrease the amount of thermal energy in response to the temperature profile being relatively steeper than the predetermined temperature profile.

### BRIEF DESCRIPTION OF THE DRAWINGS

FIG. 1 illustrates an exemplary machine, according to an aspect of the disclosure.

FIG. 2 shows a schematic view of the exemplary machine, according to an aspect of the disclosure.

FIG. 3 shows a schematic view of a standby system, according to an aspect of the disclosure.

FIG. 4 shows a schematic view of a controller suitable for use in the system, according to an aspect of the disclosure.

FIG. 5 shows a method of standby heating, according to an aspect of the disclosure.

### DETAILED DESCRIPTION

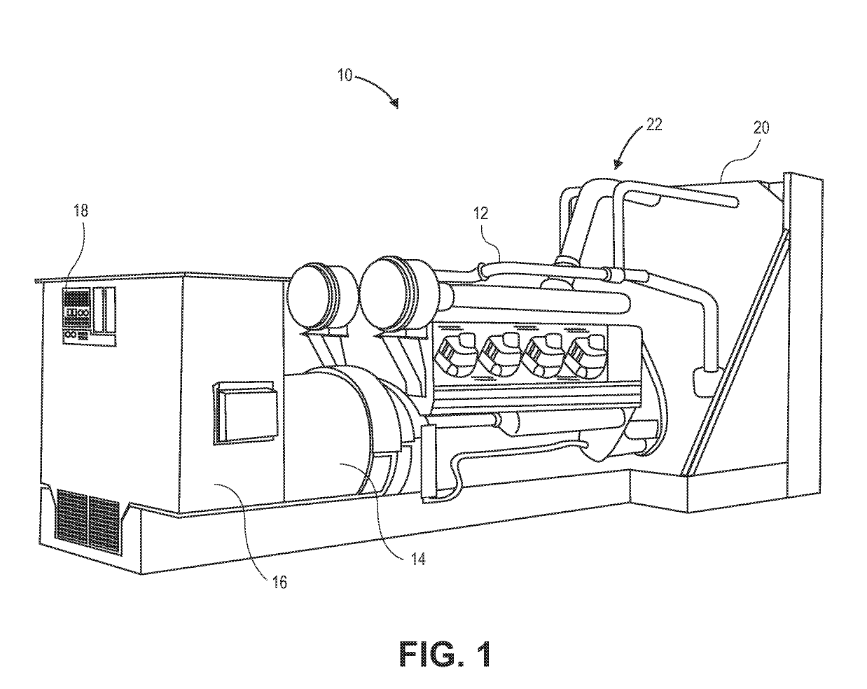

FIG. 1 illustrates an exemplary machine 10 having various systems and components that cooperate to accomplish a task. The machine 10 may embody a fixed or mobile machine that performs some type of operation associated with an industry such as power generation, transportation, mining, construction, farming, or another industry known in the art. For example, the machine 10 may be an engine driven electricity generating system or “genset” (shown in FIG. 1), a power system for a vehicle such as a locomotive, ship, or truck, or other such machine. The machine 10 may include a power source 12 or other prime mover that provides power to an electrical generator 14 configured to generate electrical power in response to the power (typically torque) provided by the power source 12. A power distribution assembly 16 is configured to receive the electrical power from the electrical generator 14 and provide electrical power to any suitable device, electrical system, or electrical grid. The machine may include a user interface 18 or other such control interfaces for manual control, testing, user input, and/or monitoring of the machine.

To remove waste heat from the power source 12, the machine 10 may include a radiator 20. Typically, a fluid such as a water-based coolant is circulated through a fluid path that circulates between the power source 12 and the radiator 20. In practice, the coolant flows through the power source 12 to collect waste heat and then through the radiator 20 to give up the waste heat into the air or other heat sink.

If the machine 10 has a minimum starting temperature, a standby system 22 may be configured to provide heat to the coolant and circulate the warmed coolant through the power source 12. In this manner, the machine 10 may be maintained in a ready to start mode.

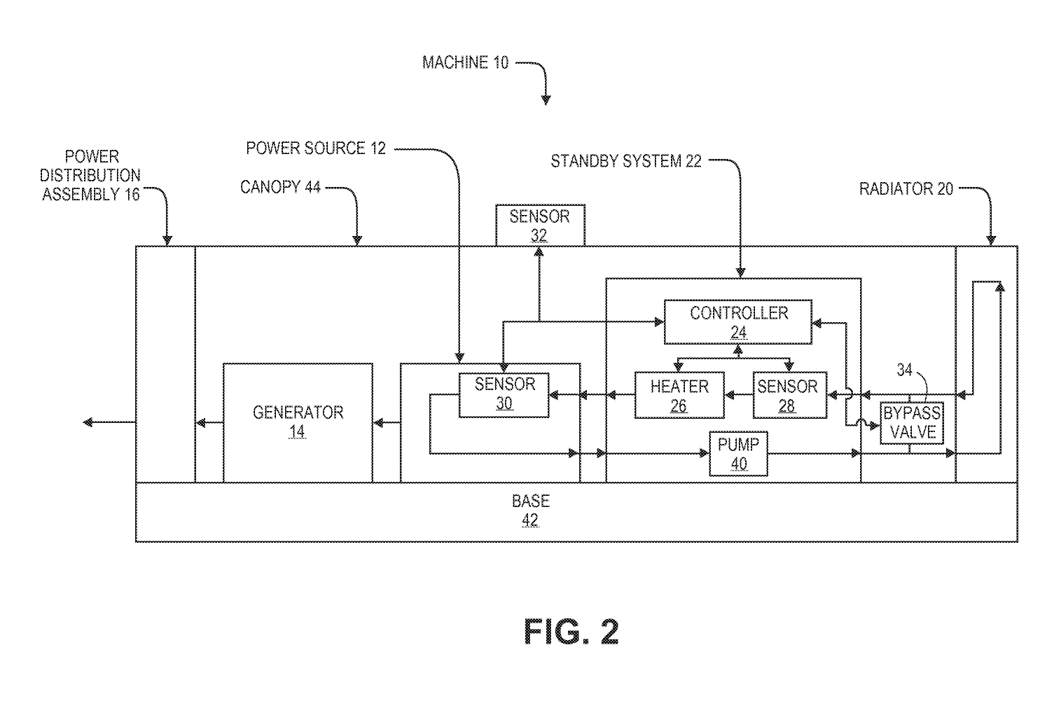

FIG. 2 shows a schematic view of the machine 10, according to an aspect of the disclosure. As shown in FIG. 2, the standby system 22 includes a controller 24 configured to send signals to and/or receive signals from a heater 26, one or more sensors 28-32, and a bypass valve 34. The heater 26 is thermally coupled to the coolant and configured to impart heat into the coolant. That is, the heater 26 may be in direct contact with the coolant or may indirectly contact the coolant via a thermally conductive material. In some embodiments the heater 26 may be immersed in the coolant or the coolant may flow through the heater 26. As described herein, the heater 26 may be disposed in any suitable location along the coolant path. For example, the heater 26 may be disposed in or on the power source 12, the radiator 20, and/or there between.

In various embodiments, the standby system 22 may include any one of the sensors 28-32, any two of the sensors 28-32, or all three of the sensors 28-32. In yet other embodiments, additional sensors may be included. In general, the sensors 28-32 are thermally coupled to the coolant, and so, may directly sense the temperature of the coolant or indirectly sense the temperature of the coolant via a thermally conductive body such as the power source 12. The sensor 28 may be configured to sense the temperature of the coolant just prior to entering the heater 26. In this manner, a minimum system temperature may be determined. The sensor 30 may be configured to sense the temperature of the power source 12. The sensor 32 may be configured to sense an ambient temperature. Some or all of these sensed temperatures may be utilized by the controller 24 to modulate an amount of heat imparted to the coolant by the heater 26. In addition, although each sensor 28-32 is shown as a single sensor, some or all of the sensors 28-32 may include two or more sensing elements and measurements from these elements may be averaged and/or provide redundancy in case of a sensor issue.

Also shown in FIG. 2, the machine 10 may include a pump 40, an optional base 42, and an optional canopy 44. The pump 40 may be configured to continuously circulate the coolant through the machine 10. In other embodiments, the controller 24 and/or other controllers may be configured to control the pump 40. If included, the base 42 is configured to provide a platform upon which the various components of the machine 10 may be affixed. In other embodiments, the various components of the machine 10 may be affixed to another foundation such as, for example, a poured concrete foundation or the like. If included, the canopy 44 may be configured to shelter the machine 10 from the elements and/or abate noise.

Of note, although the various components of the standby system 22 are shown, diagrammatically, as a unit separate from the power source 12 and radiator 20, in practice, some or all of the components may be subsumed within other components of the machine 10. For example, the heater 26 may be disposed within the power source 12. In another example, the pump 40 may be disposed within either the power source 12 or the radiator 20.

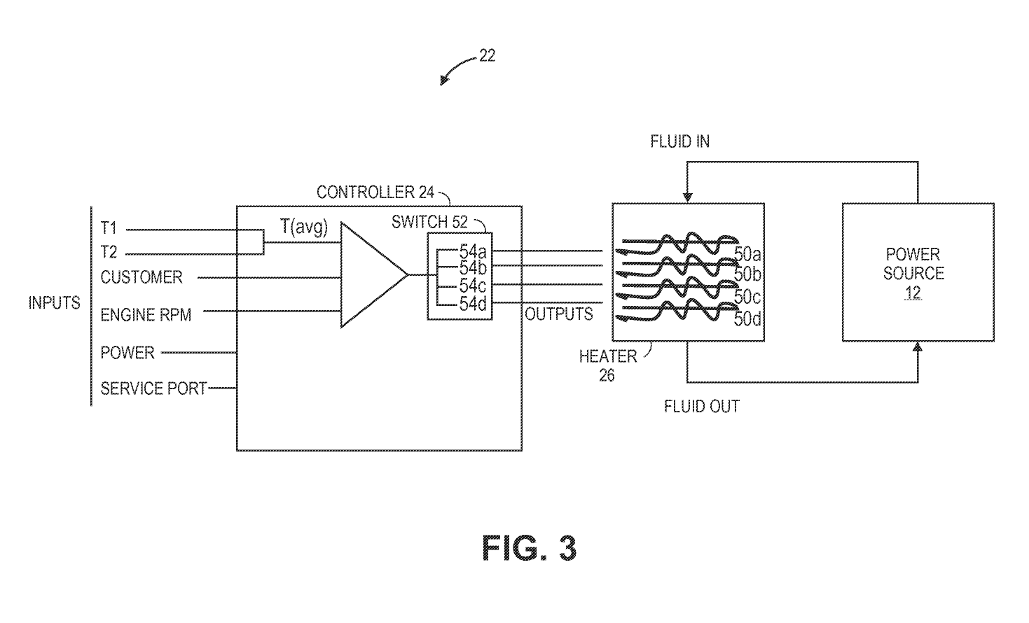

FIG. 3 shows a schematic view of the standby system 22, according to an aspect of the disclosure. As shown in FIG. 3, the heater 26 may include a plurality of heating elements 50A-50D and the controller 24 is configured to individually power these heating elements 50A-50D via a switch 52. The switch 52 may include a plurality of relays or contacts 54A-54D configured to individually power the corresponding heating elements 50A-50D. As described herein, more or fewer of the heating elements 50A-50D may be powered in response to sensed temperatures in and around the machine 10 and/or a temperature profile of a change in temperature over time.

The temperature profile may be based on a variety of factors such as, for example, a change in temperature over time calculated to reduce power consumption, a user input temperature profile, a user input time to achieve a temperature, manufacturer's recommendations, empirical data, and the like. The temperature of the coolant, and therefore the power source 12, may be cycled from about an operating temperature to a predetermined high temperature. In a particular example, the operating temperature may be about 100° F. (38° C.) and the predetermined high temperature may be about 130° F. (54° C.). Viewed over a time frame that includes several cycles, the rise and fall of the temperature in the temperature profile resembles a saw tooth pattern. In general, it is the slope of the line from the operating temperature to the predetermined high temperature that is controlled by modulating the amount of heat being imparted into the coolant.

Also shown in FIG. 3, an input for the controller 24 may include an engine revolution per minute (RPM) measurement. In some embodiments, the controller 24 may be configured to de-power the heater 26 in response to a sensed running of the power source 12.

Of note, while in the particular example of the heater 26 shown in FIG. 3 includes a plurality of contacts 54A-54D corresponding to a plurality of heating elements 50A-50D, in other examples the amount of heat energy produced by the heater 26 may be modulated in any suitable manner by the controller 24. For example, the controller 24 may be configured to power and depower the heater 26 at a frequency and the frequency may be modulated to control the amount of heat output from the heater 26. In another example, the controller 24 may be configured to vary an amount of electrical energy provided to the heater 26 in order to modulate the heat output of the heater 26. In some specific examples, the controller 24 may be configured to modulate a variac transformer, autotransformer, or the like.

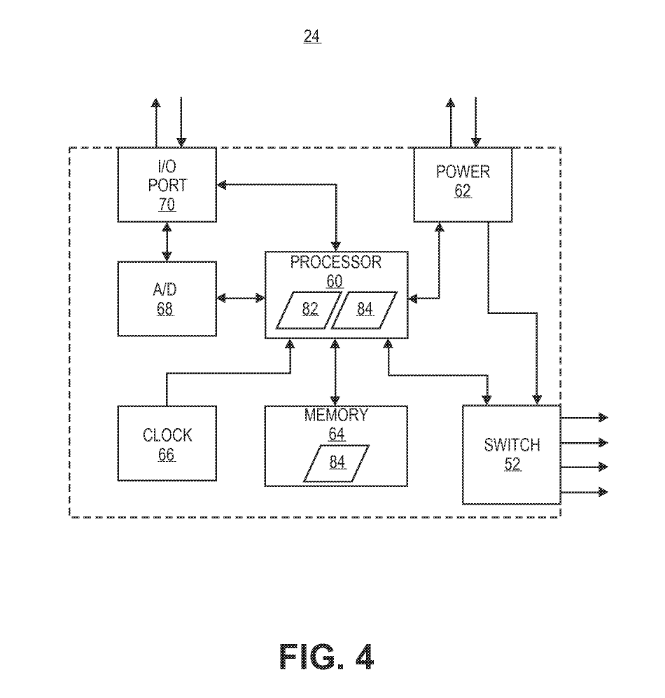

FIG. 4 shows a schematic view of the controller 24 suitable for use in the standby system 22. As shown in FIG. 4, the controller 24 includes a processor 60. This processor 60 is operably connected to a power supply 98, memory 64, clock 66, analog to digital converter (A/D) 68, and an input/output (I/O) port 70. The I/O port 70 is configured to receive signals from any suitably attached electronic device and forward these signals to the A/D 68 and/or the processor 60. For example, the I/O port 70 may receive signals associated with temperature measurements from one or more of the sensors 28-32 and forward the signals to the processor 60. In another example, the I/O port 70 may receive signals via the user interface 18 shown in FIG. 1 and forward the signals to the processor 60. If the signals are in analog format, the signals may proceed via the A/D 68. In this regard, the A/D 68 is configured to receive analog format signals and convert these signals into corresponding digital format signals. Conversely, the A/D 68 is configured to receive digital format signals from the processor 60, convert these signals to analog format, and forward the analog signals to the I/O port 70. In this manner, electronic devices configured to receive analog signals may intercommunicate with the processor 60.

The processor 60 is configured to receive and transmit signals to and from the A/D 68 and/or the I/O port 70. The processor 60 is further configured to receive time signals from the clock 66. In addition, the processor 60 is configured to store and retrieve electronic data to and from the memory 64. Furthermore, the processor 60 is configured to determine signals operable to modulate the heater 26 and thereby control the amount of heat imparted to the coolant. For example, in response to the processor 60 determining an insufficient amount of heat is being imparted into the coolant, the processor 60 may forward signals to the switch 52 to power an additional heating element 50A-50D.

According to an embodiment of the present disclosure, the processor 60 is configured to execute a code 82. In this regard, the standby system 22 includes a set of computer readable instructions or code 82. According to the code 82, the controller 24 is configured to modulate an amount of heat imparted into the coolant by the heater 26. In addition, the controller 24 may be configured to generate and store data to a file 84. This file 84 includes one or more of the following: sensed temperatures; timestamp information; determined temperature profiles; user input temperature profiles; recommended temperature profiles; and the like.

Based on the set of instructions in the code 82 and signals from one or more of the sensors 28-32, the processor 60 is configured to: determine the temperature profile of the power source 12, the coolant, and/or the other components of the machine 10; and determine whether the temperature profile is within a predetermined acceptable deviation from a predetermined temperature profile. For example, the processor 60 receives the sensed temperature and/or an average sensed temperature, compares this to previous temperatures over time to determine the current temperature profile. The processor compares the current temperature profile to the predetermined temperature profile. The processor 60 determines whether any deviation from the predetermined temperature profile is within the predetermined acceptable deviation. If the current temperature profile deviation from the predetermined temperature exceeds the predetermined acceptable deviation, the processor 60 further determines which contact 54A-54D to modulate in order to impart an amount of heat into the coolant that is calculated to result in the calculated temperature profile more closely matching the predetermined temperature profile. In this manner, the temperature profile of the power source 12 is controlled to closely match the predetermined temperature profile.

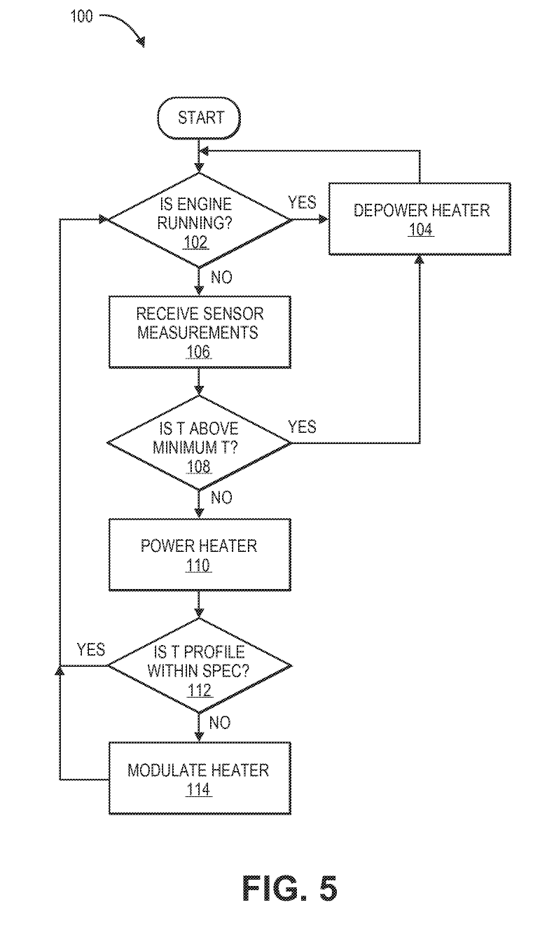

FIG. 5 shows a method 100 of standby heating, according to an aspect of the disclosure. Prior to the initiation and/or during the performance of the method 100, a variety of procedures may be performed such as, for example, the predetermined temperature profile and/or acceptable deviations from the predetermined temperature profile may be input and/or stored to the file 84, system checks may be performed, calibrations of the sensors 28-32 may be performed, and the like. As shown in FIG. 5, the method 100 is initiated at step 102 where it is determined if the power source 12 is running. If it is determined the power source 12 is running, the heater 26 may be deactivated and the bypass valve 34 may be controlled to close at step 104. If it is determined the power source 12 is not running, sensor measurements may be received at step 106.

At step 106, one or more of the sensors 28-32 may forward a signal corresponding to a sensed temperature to the controller 24. Some or all of these sensed temperatures may be averaged and/or checked for anomalies by the controller 24 in order to determine a calculated temperature.

At step 108, the calculated temperature is compared to a predetermined minimum temperature. For example, the power source 12 may include a minimum recommended temperature for starting of about 100° F. (38° C.). If it is determined the calculated temperature is above the predetermined minimum temperature, the heater 26 may be depowered at step 104. If the heater is not already powered and it is determined the calculated temperature is below the predetermined minimum temperature, the heater 26 may be powered at step 110.

At step 112, the calculated temperature and time stamp may be used along with previous calculated temperatures and their corresponding time stamps by the controller 24 to calculate the current temperature profile. The current temperature profile may be compared to the predetermined temperature profile to determine if the current temperature profile is within the acceptable deviation from the predetermined temperature profile. If the current temperature profile is within the acceptable deviation from the predetermined temperature profile, it may be determined if the power source 12 is running at step 102. If the current temperature profile is not within the acceptable deviation from the predetermined temperature profile, the heater 26 may be modulated at step 114.

At step 114 the heater 26 may be modulated. For example, if the current temperature profile is steeper than the predetermined temperature profile, the heater 26 may be controlled to impart less heat into the coolant. In a particular example, if heating elements 50A, 50B, and 50C are currently being powered, the controller 24 may determine that heating element 50C is to be depowered and signals to that effect may be forwarded to the switch 52. In another example, if the current temperature profile is shallower than the predetermined temperature profile, the heater 26 may be controlled to impart more heat into the coolant. In a particular example, if heating elements 50A, 50B, and 50C are currently being powered, the controller 24 may determine that heating element 50D is to be powered and signals to that effect may be forwarded to the switch 52.

### INDUSTRIAL APPLICABILITY

The present disclosure may be applicable to any machine including a genset or other machine having a standby mode. Aspects of the disclosed standby system and method may promote operationally flexibility, performance, reduced wear, improved maintenance, and energy efficiency of genset and other systems.

Applicants discovered that a conventional approach of applying full power to standby heaters may result in efficiency losses, increased power consumption, increased wear of heating elements, and increased thermal stress to components of the genset. For example, relatively fast increases in temperature may result in one part of an engine heating more quickly than another part and thermal expansion across regions of temperature differences may result in stress across this area. In addition, relatively slower rises in temperature result in a lowered number of thermal cycles overall. Then, at that same time, rapid heating and cooling of the standby heater may lead to the premature failure of the heater and need for the heater to be replaced with greater frequency. In turn, the rapid heating of the coolant may use more power than a less rapid heating of the coolant due to decreases in efficiency when components are operating at full capacity. However, a simple reduction in heating capacity may not be a solution because variable ambient temperatures may demand a relatively large heating capacity be available at some times.

According to an aspect of the disclosure shown in FIG. 3, each of the heating elements 50A-50D may be individually controlled to heat the coolant or not, thereby providing an ability to modulate an amount of heat imparted into the coolant and therefore a temperature profile over time of the power source 12. Thus, instead of rapid temperature changes when ambient temperatures are relatively high, the temperature profile may be maintained irrespective of ambient temperatures. Further, as discussed above, the lifespan of the heater 26 maybe improved.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified.

We claim:

1. A standby system, comprising:
a pump fluidly coupled to a power source and configured to convey a flow of a coolant through the power source;
a heater thermally coupled to the coolant and configured to impart an amount of thermal energy into the coolant;
a sensor thermally coupled to the coolant;
a controller operatively coupled to the heater and the sensor, the controller being configured to:
receive a plurality of signals over time from the sensor,
determine a temperature profile based on the plurality of signals over time,
compare the temperature profile to a predetermined temperature profile,
modulate the heater to increase the amount of thermal energy in response to the temperature profile being relatively more shallow than the predetermined temperature profile, and
modulate the heater to decrease the amount of thermal energy in response to the temperature profile being relatively steeper than the predetermined temperature profile.

2. The standby system according to claim 1, further comprising:
a plurality of individually controllable heating elements making up the heater, wherein the controller is configured to modulate the heater by individually controlling ones of the plurality of individually controllable heating elements to be powered and depowered.

3. The standby system according to claim 1, further comprising:
a plurality of the sensors, wherein the controller is configured to average signals from the plurality of the sensors to determine an average temperature.

4. The standby system according to claim 1, wherein the controller is further configured to determine a current temperature based on the plurality of signals over time and power the heater in response to the current temperature being below a predetermined minimum temperature.

5. The standby system according to claim 1, wherein the controller is further configured to receive a revolution per minute (RPM) signal and depower the heater in response to the RPM signal being greater than zero.

6. The standby system according to claim 1, further comprising:
a user interface to input the predetermined temperature profile.

7. The standby system according to claim 1, wherein the controller is further configured to determine if the temperature profile is outside an acceptable deviation from the predetermined temperature profile and, if the temperature profile is outside the acceptable deviation from the predetermined temperature profile, the controller is configured to modulate the heater to bring the temperature profile within the acceptable deviation from the predetermined temperature profile.

8. A machine comprising the standby system according to claim 1.

9. The machine according to claim 8, wherein the power source is a diesel engine.

10. The machine according to claim 9, wherein the machine is a genset.

11. The machine according to claim 9, wherein the machine is a locomotive.

12. The machine according to claim 9, wherein the machine is a ship.

13. A method of operating a standby system, the standby system including:
a pump fluidly coupled to a power source and configured to convey a flow of a coolant through the power source;
a heater thermally coupled to the coolant and configured to impart an amount of thermal energy into the coolant;
a sensor thermally coupled to the coolant;
a controller operatively coupled to the heater and the sensor, the method comprising:
receiving, at the controller, a plurality of signals over time from the sensor,
determining, with a processor disposed in the controller, a temperature profile based on the plurality of signals over time,
comparing, with the processor, the temperature profile to a predetermined temperature profile,
modulating, with the controller, the heater to increase the amount of thermal energy in response to the temperature profile being relatively more shallow than the predetermined temperature profile, and
modulating, with the controller, the heater to decrease the amount of thermal energy in response to the temperature profile being relatively steeper than the predetermined temperature profile.

14. The method according to claim 13, further comprising:
modulating, with the controller, the heater by individually controlling ones of a plurality of individually controllable heating elements disposed in the heater to be powered and depowered.

15. The method according to claim 13, further comprising:
averaging, with the processor, a plurality of signals from a plurality of the sensors to determine an average temperature.

16. The method according to claim 13, further comprising:
determining, with the processor, a current temperature based on the plurality of signals over time and power the heater in response to the current temperature being below a predetermined minimum temperature.

17. The method according to claim 13, further comprising:
receiving, at the controller, a revolution per minute (RPM) signal and depower the heater in response to the RPM signal being greater than zero.

18. The method according to claim 13, further comprising:
receiving, from a user interface, the predetermined temperature profile.

19. The method according to claim 13, further comprising:
determining, with the processor, if the temperature profile is outside an acceptable deviation from the predetermined temperature profile.

20. The method according to claim 19, further comprising:
modulating the heater to bring the temperature profile within the acceptable deviation from the predetermined temperature profile in response to the temperature profile being outside the acceptable deviation from the predetermined temperature profile.
